(19) United States
(12) Patent Application Publication
(10) Pub. No.: US 2012/0313962 A1
(43) Pub. Date: Dec. 13, 2012

(54) ELECTRONIC DEVICE AND METHOD FOR GENERATING GRAPHICAL USER INTERFACE THEREOF

(75) Inventors: Yu-Ting Hsu, Taipei City (TW); Fei Wu, Taipei City (TW); Ming-Che Weng, Taipei City (TW)

(73) Assignee: COMPAL ELECTRONICS, INC., Taipei City (TW)

(21) Appl. No.: 13/154,447

(22) Filed: Jun. 7, 2011

(51) Int. Cl. G09G 5/02; G06F 3/048

(52) U.S. Cl. 345/593; 715/765

(57) ABSTRACT

An electronic device and a method for generating a graphical user interface thereof are provided. In the method, a color of a background image with a predetermined size for an application program is determined according to a dynamic styling rule. Then, the color is applied to the background image, and the background image is combined with an icon of the application program, so as to generate a rimmed icon of the application program. Finally, the rimmed icon is displayed in the GUI of the electronic device. The rimmed icons generated by the present method are uniform in shape and size, and the color of each background image is also meaningful. Hence, the user may find the needed icon from the GUI rapidly and conveniently.

### BACKGROUND OF THE INVENTION

1. Field of the Invention

The present invention relates to a graphical user interface (GUI). More particularly, the present invention relates to a method for generating the GUI containing icons of application programs and an electronic device using the same.

2. Description of Related Art

Along with the development of technology, the popularity of the use of the information processing system has greatly increased. For example, nowadays people have become more and more accustomed in daily life to doing work on a computer system, receiving/sending emails through a computer system, or browsing the web and playing multimedia files through a computer system.

Conventional types of computer systems were operated through text-based operating systems, but modern computer systems are mostly operated through graphical user interface (GUI) based operating systems. With a GUI-based operating system, the user can easily and conveniently interact with the computer systems through the GUI.

A kind of GUI object such as an application program icon allows the user to launch the corresponding application program through the GUI. The icon of each application program is displayed in the GUI to facilitate the user in identifying a type of the application program from the icon. However, the icons of different application programs may have irregular shape and size. Obviously, displaying the icons which are irregular in shape and size makes the appearance of the GUI indiscriminate, leading to inconvenient management of the icons.

### SUMMARY OF THE INVENTION

Accordingly, the present invention is directed to a method for generating a graphical user interface (GUI) and an electronic device, which provides a convenient manner for a user to manage application program icons in the GUI.

The invention provides a method for generating a GUI of an electronic device. In the method, a color of a background image with a predetermined size for an application program is determined according to a dynamic styling rule, and the color is applied to the background image. The background image and an icon of the application program are combined to generate a rimmed icon, and then the rimmed icon is displayed in the GUI.

According to an embodiment of the present invention, wherein the dynamic styling rule is relevant to at least one of an attribute of the application program and a usage situation of the electronic device.

According to an embodiment of the present invention, in the step of determining the color of the background image according to the dynamic styling rule, a plurality of predetermined function categories and a predetermined color corresponding to each of the predetermined function categories are obtained. A function category of the application program is analyzed. If the function category of the application program is consistent with one of the predetermined function categories, the color of the background image is defined as the predetermined color corresponding to the consistent predetermined function category.

According to an embodiment of the present invention, in the step of determining the color of the background image according to the dynamic styling rule, a color distribution of the icon of the application program is analyed, and a dominant color is picked according to the color distribution. Then, the color of the background image is defined as the dominant color.

According to an embodiment of the present invention, in the step of determining the color of the background image according to the dynamic styling rule, a color tone of a current wallpaper of the electronic device is analyed when a wallpaper altering signal is detected, and the color of the background image is mathched with the color tone.

According to an embodiment of the present invention, in the step of determining the color of the background image according to the dynamic styling rule, a user of the electronic device is identified, and the color of the background image is determined according to an identity of the user.

According to an embodiment of the present invention, the method for generating the GUI further applies the color to a wallpaper of electronic device.

According to an embodiment of the present invention, the method for generating the GUI further repeats the step of determining the color of the background image, the step of applying the color to the background image, and the step of combining the background image with the icon of the application program, so as to generate a plurality of rimmed icons, and displaying the rimmed icons in the GUI.

According to an embodiment of the present invention, in the step of displaying the rimmed icons in the GUI, the rimmed icons with the background image having the similar color are displayed together in the GUI.

According to an embodiment of the present invention, wherein the background image is a filled rectangular shape or a hollow rectangular shape or has a shift distance of the icon or has a shift angle of the icon.

The invention provides an electronic device including a screen, a color determining module, and a GUI rendering module. The screen displays a GUI of the electronic device. The color determining module determines a color of a background image with a predetermined size for an application program according to a dynamic styling rule. The GUI rendering module is coupled to the screen and the color determining module. The GUI rendering module applies the color to the background image, combines the background image with an icon of the application program to generate a rimmed icon, displays the rimmed icon in the GUI, and dominates the screen to display the GUI.

According to an embodiment of the present invention, wherein the dynamic styling rule is relevant to at least one of an attribute of the application program and a usage situation of the electronic device.

According to an embodiment of the present invention, the color determining module obtains a plurality of predetermined function categories and a predetermined color corresponding to each of the predetermined function categories, and analyzes a function category of the application program, If the function category of the application program is consistent with one of the predetermined function categories, the color determining module defines the color of the background image as the predetermined color corresponding to the consistent predetermined function category.

According to an embodiment of the present invention, the color determining module analyzes a color distribution of the icon of the application program, picks a dominant color according to the color distribution, and defines the color of the background image as the dominant color.

According to an embodiment of the present invention, the color determining module analyzes a color tone of a current wallpaper of the electronic device when a wallpaper altering signal is detected, and matches the color of the background image with the color tone.

According to an embodiment of the present invention, the color determining module identifies a user of the electronic device; and defines the color of the background image according to an identity of the user.

According to an embodiment of the present invention, the color determining module applys the color to a wallpaper of electronic device.

According to an embodiment of the present invention, wherein the color determining module determines the color of the background image for each of a plurality of application programs according to the dynamic styling rule. For each of the application programs, the GUI rendering module applies the color to the corresponding background image, combines the background image with a corresponding icon of the application program, so as to generate a plurality of rimmed icons corresponding to the application programs. The GUI rendering module displays the rimmed icons in the GUI.

According to an embodiment of the present invention, the GUI rendering module displays together the rimmed icons with the background image having the similar color in the GUI.

According to an embodiment of the present invention, wherein the background image is a filled rectangular shape or a hollow rectangular shape or has a shift distance of the icon or has a shift angle of the icon.

In the present invention, icons of application programs to be displayed in a GUI of an electronic device are respectively combined with a background image to become rimmed icons having identical shape and size, so as to keep the appearance of the GUI orderly. In addition, the color of the background image of each rimmed icon is determined according to a dynamic styling rule, the user may get more information about the application program icon by the background image color. Thereby, it is made very convenient and intuitional to manage the rimmed icons in the GUI.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic device according to an embodiment of the present invention.

FIG. 2 is a flow chart of a method for generating a graphical user interface (GUI) of an electronic device according to an embodiment of the present invention.

FIG. 3 is a diagram illustrating a rimmed icon according to an embodiment of the invention.

FIG. 4 is a diagram illustrating a rimmed icon according to another embodiment of the invention.

FIG. 5 is a diagram illustrating a rimmed icon according to yet another embodiment of the invention.

FIG. 6 is a diagram illustrating a rimmed icon according to still another embodiment of the invention.

FIG. 7 is a diagram illustrating a relationship between a plurality of predetermined function categories and a plurality of predetermined colors.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

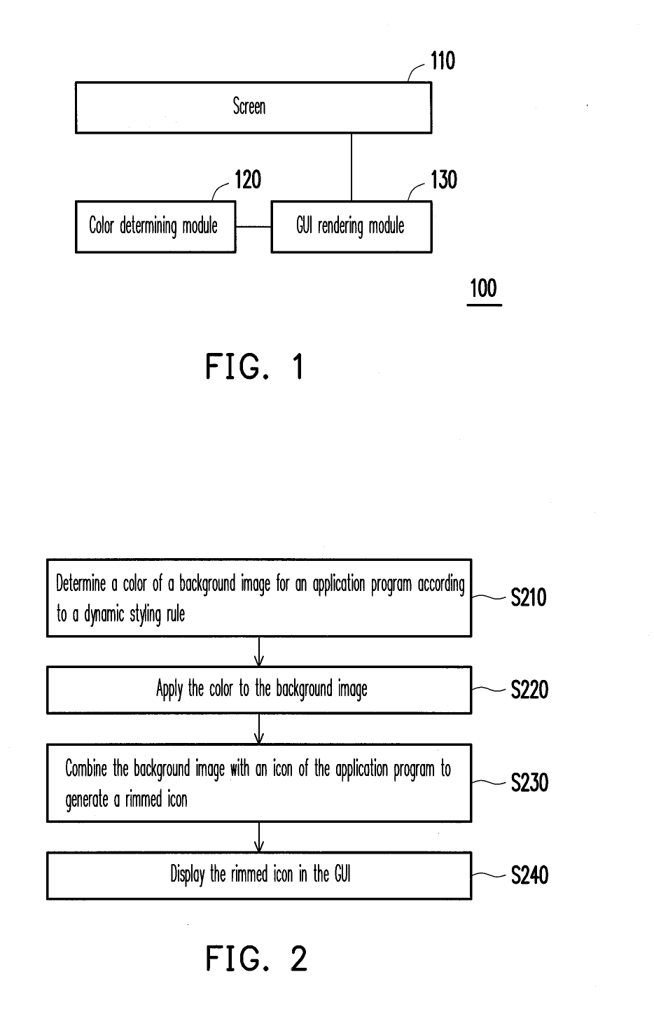

FIG. 1 is a block diagram of an electronic device according to an embodiment of the present invention. Referring to FIG. 1, the electronic device 100 includes a screen 110, a color determining module 120, and a GUI rendering module 130. In the present embodiment, the electronic device 100 may be a desktop computer, a laptop computer, a tablet PC, a cell phone, a personal digital assistant (PDA), or a smart phone. However, the type of the electronic device 100 is not limited herein.

The screen 110 is, for example, a liquid crystal display (LCD), a capacitive touch screen, a resistive touch screen, or an optical touch screen. The screen 110 is configured to display various operation frames of the electronic device 100. For example, a graphical user interface (GUI) of the electronic device 100 is displayed on the screen 110, allowing a user to interact with the electronic device 100. The GUI provides one or more icons that respectively correspond to application programs, so that the application programs can be launched through the icons. Generally, the user may select a wallpaper as a background of the GUI.

The color determining module 120 is configured to determine a color of a background image for each icon to be displayed in the GUI. For example, each background image may be the same size as the corresponding icon. Alternatively, the size of each background image may be larger than that of the corresponding icon. In the present embodiment, the color determining module 120 may be any functional module implemented by hardware and/or software, where the hardware includes a central processing unit (CPU), a chipset, a microprocessor, a controller, an application specific integrated circuit (ASIC), a programmable logic device (PLD) or a control circuit, etc., or combinations thereof, and the software may be an operating system (OS), a driving program, or an application program (AP), etc.

The GUI rendering module 130 is coupled to the screen 110 and the color determining module 120. The GUI rendering module 130 is configured to render the GUI in accord and with the determination of color provided by the color determining module 120, and dominate the screen 110 to display the GUI. In the present embodiment, the GUI rendering module 130 may be a CPU, a programmable general purpose or special purpose microprocessor, a controller, an ASIC, a programmable logic device (PLD), or other similar devices or combinations thereof. The GUI rendering module 130 may also be a module such as an operating system, a driving program or an application program, etc implemented by software. Alternatively, the GUI rendering module 130 may also be commonly implemented by software and a hardware device having a processing function.

Below, the operation of the electronic device 100 will be described in detail with reference to another embodiment of the invention. FIG. 2 is a flow chart of a method for generating a GUI of an electronic device according to the embodiment of the present invention. Please refer to both FIG. 1 and FIG. 2. In this embodiment, the GUI may contain one or more icons of application programs, but for the convenience of description, only one icon of an application program is used for description in the following.

In step S210, the color determining module 120 determines a color of a background image with a predetermined size for the application program according to a dynamic styling rule. In the present embodiment, the dynamic styling rule is relevant to at least one of an attribute of the application program and a usage situation of the electronic device 100. To be specific, the attribute of the application program may be a function category, a color distribution of the original icon of the application program, a usage frequency, or an updating date of the application program. Alternatively, the attribute of the application program may also be the combination of the foregoing properties. On the other hand, the usage situation of the electronic device 100 may be a user of the electronic device 100, a color tone of a current wallpaper of the electronic device 100, or the remaining power of the electronic device 100, etc. The dynamic styling rule may be set by the user or predetermined by the electronic device 100.

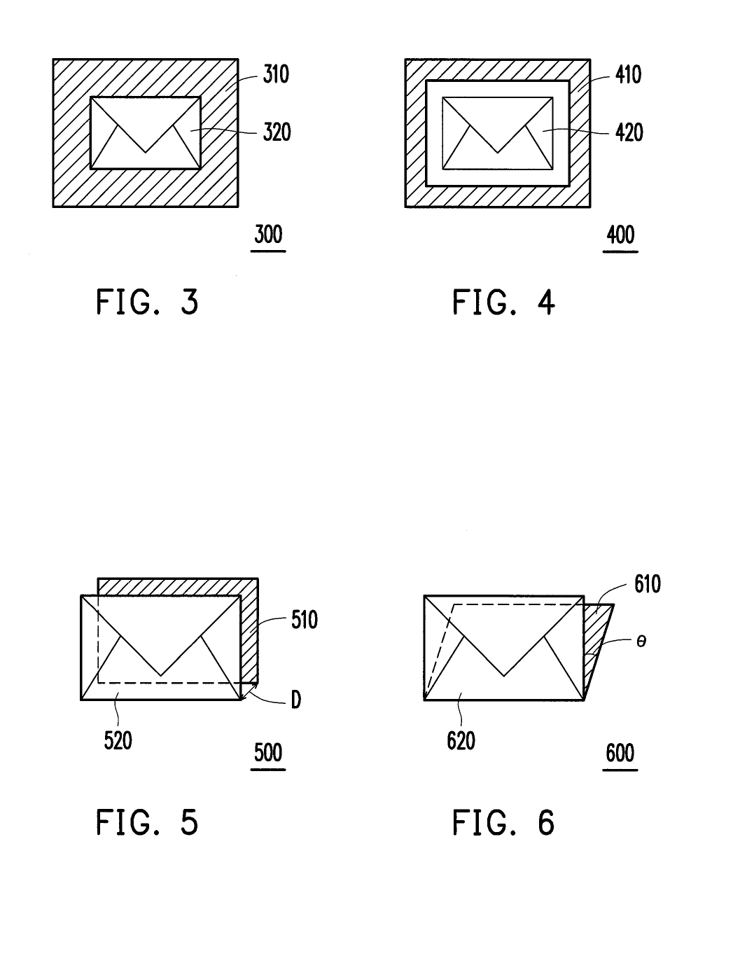

Then, in step S220, the GUI rendering module 130 applies the color to the background image. In step S230, the GUI rendering module 130 combines the background image with an icon of the application program to generate a rimmed icon. In one embodiment, the background image is a filled rectangular shape and larger than the corresponding icon, and the rimmed icon 300 is as shown in FIG. 3 through the operations of the color determining module 120 and the GUI rendering module 130. Referring to FIG. 3, the original icon 320 is placed at the center of the background image 310. In another embodiment, the background image is a hollow rectangular shape and larger than the corresponding icon, and the rimmed icon 400 is as shown in FIG. 4 through the operations of the color determining module 120 and the GUI rendering module 130. Referring to FIG. 4, the original icon 420 is placed at the center of the background image 410, thus the background image 410 is like a frame around the original icon 420. It should be noted that whether the filled rectangular shape or the hollow rectangular shape described above is only an example of the background image but not intended to limit the invention. In yet another embodiment, the background image and the corresponding icon are in the same size. For example, as shown in FIG. 5, the rimmed icon 500 with a shadow effect is created by placing the background image 510 behind the original icon 520 in accordance with a shift distance D, wherein the size and the shape of the background image 510 and the original icon 520 are identical. Referring to FIG. 6, the rimmed icon 600 with the shadow effect is created by placing the background image 610 behind the original icon 620 in accordance with a shift angle θ, wherein the background image 610 and the original icon 620 have the same measure of area. It should be noted that whether the background image has a texture effect or a gradient effect is not by the invention.

In the last step S240, the GUI rendering module 130 displays the rimmed icon in the GUI and dominates the screen 110 to display the GUI. Through the steps illustrated in FIG. 2, the rimmed icon displayed in the GUI has a background image with color corresponding to the dynamic styling rule, so that the user may get more information about the application program corresponding to the rimmed icon through the color of the background image. If a plurality of icons corresponding to a plurality of application programs are to be displayed in the GUI, step S210 to step S230 in FIG. 2 will be executed for each application program, so as to generate a plurality of rimmed icons corresponding to the application programs respectively. Then, the GUI rendering module 130 displays the rimmed icons which are uniform in shape and size in the GUI. Therefore, the user may move and place the rimmed icons arbitrarily, and get more information of the corresponding application program by the background image color, so as to facilitate finding icons and managing them.

In the foregoing embodiments, the GUI rendering module 130 directly displays the rimmed icons in the GUI. The position of each rimmed icon is then determined by the user. Alternatively, the GUI rendering module 130 automatically displays the rimmed icons with the background image having the similar color together in the GUI, thus the user may easily obtain information of all icons displayed in the GUI and thereby launch the application programs promptly.

Below, the operation of the electronic device 300 corresponding to different dynamic styling rule will be described by several embodiments.

In one embodiment, it is assumed that the dynamic styling rule is relevant to a function category of the application program. When determining a color of a background image for an application program, the color determining module 120 obtains a plurality of predetermined function categories and a predetermined color corresponding to each of the predetermined function categories from a storage unit (not shown) of the electronic device 100, and analyzes the function category of the application program. If the function category of the application program is consistent with one of the predetermined function categories, the color determining module 120 defines the color of the background image as the predetermined color corresponding to the consistent predetermined function category. However, if the function category of the application program is not consistent with any predetermined function category, the color determining module 120 may defines the color of the background image as a default color.

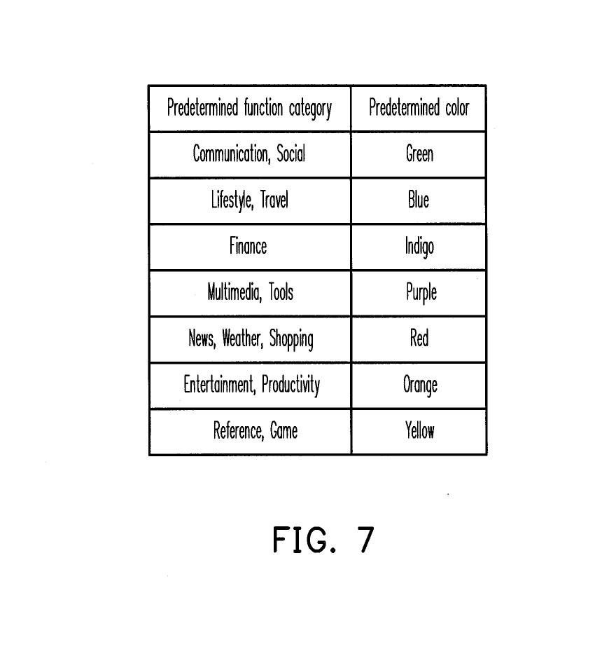

As shown in FIG. 7, it is assumed that the storage unit records 7 predetermined function categories and the 7 predetermined colors corresponding to the predetermined function categories respectively. When generating a rimmed icon for an application program such as a multimedia player, the color determining module 120 consults the 7 predetermined function categories and pick purple as the color of the background image for the multimedia player, and the GUI rendering module 130 generates the rimmed icon with purple background accordingly. In this embodiment, since the application programs belonging to the same function category will have same background image color, it provides an easy way for the user to group the rimmed icons corresponding to the same function category together, so that the management of icons may become more efficient.

In one embodiment, it is assumed that the dynamic styling rule is relevant to a color distribution of the original icon of an application program. Accordingly, when determining a color of a background image for the application program, the color determining module 120 has to analyze the color distribution of the icon of the application program, and then picks a dominant color according to the color distribution. For example, the color determining module 120 may pick the dominant color except for black, white and gray. Finally, the color determining module 120 defines the color of the background image as the dominant color, and the GUI rendering module 130 generates the rimmed icon in accordance with the color determined by the color determining module 120. As a result, the color tint of the rimmed icon is consistent with the original icon. Moreover, the background image may enhance the impression of the rimmed icon, capable of assisting the user to rapidly get the needed icon effectively.

As another embodiment, it is assumed that the dynamic styling rule is relevant to a color tone of a current wallpaper of the electronic device 100. To be specific, when the user changes the wallpaper of the electronic device 100 or alters the color tone of the wallpaper, a wallpaper altering signal is generated. Accordingly, when the color determining module 120 detects the wallpaper altering signal, the color determining module 120 analyzes the color tone of the current wallpaper, and matches the color of the background image with the color tone. The GUI rendering module 130 then generates the rimmed icon in accordance with the color determined by the color determining module 120. Therefore, the color tint of the rimmed icons will be consistent with the wallpaper of the electronic device 100, so that the GUI may provide a pleasant visual effect for the user.

In yet another embodiment, it is assumed that the dynamic styling rule is relevant to a user of the electronic device 100. Accordingly, the color determining module 120 has to identify the user of the electronic device 100. For example, by obtaining the user account logged into the electronic device 100. Then, the color determining module 120 defines the color of the background image according to an identity of the user. For instance, different user accounts are corresponding to different background image colors which may be selected by each user or predetermined by the electronic device 100. The GUI rendering module 130 generates the rimmed icons corresponding to each application program in accordance with the color determined by the color determining module 120. Therefore, the user may determine whether the user account logged into the electronic device 100 is his/her user account rapidly according to the background image color of the rimmed icons.

Besides generating the rimmed icon according to the dynamic styling rule, in one embodiment, the color of a wallpaper of the electronic device 100 is also determined by the dynamic styling rule. To be specific, after the color determining module 120 determines the color in accordance with the dynamic styling rule, the GUI rendering module 130 applies the color to the wallpaper of the electronic device 100, so as to improve color consistency of the GUI.

It should be noted that the color determined by the color determining module 120 is the main color of the background image and/or the wallpaper. To be specific, each background image and/or the wallpaper may be a single color image wherein the color is determined by the color determining module 120. Alternatively, each background image and/or the wallpaper may have multiple colors including the main color determined by the color determining module 120. For example, each background image and/or the wallpaper may be a gradient image such as a linear gradient image, a circular gradient image, or a radial gradient image.

In view of the above, the present invention provides an electronic device and a method for generating a GUI thereof. According to the above embodiments, the background image of the rimmed icon may be determined according to the attribute of the corresponding application program and/or the usage situation of the electronic device. Thus, the user may get more information about the application program icon through the background image color, and accordingly makes the icon management more easy and convenient.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for generating a graphical user interface (GUI) of an electronic device, the method comprising:
(a) determining a color of a background image with a predetermined size for an application program according to a dynamic styling rule;
(b) applying the color to the background image;
(c) combining the background image with an icon of the application program to generate a rimmed icon; and
(d) displaying the rimmed icon in the GUI.

2. The method according to claim 1, wherein the dynamic styling rule is relevant to at least one of an attribute of the application program and a usage situation of the electronic device.

3. The method according to claim 1, wherein the step (a) comprises:
obtaining a plurality of predetermined function categories and a predetermined color corresponding to each of the predetermined function categories;
analyzing a function category of the application program; and
if the function category of the application program is consistent with one of the predetermined function categories, defining the color of the background image as the predetermined color corresponding to the consistent predetermined function category.

4. The method according to claim 1, wherein the step (a) comprises:
analyzing a color distribution of the icon of the application program;
picking a dominant color according to the color distribution; and
defining the color of the background image as the dominant color.

5. The method according to claim 1, wherein the step (a) comprises:
when detecting a wallpaper altering signal, analyzing a color tone of a current wallpaper of electronic device; and
matching the color of the background image with the color tone.

6. The method according to claim 1, wherein the step (a) comprises:
identifying a user of the electronic device; and
defining the color of the background image according to an identity of the user.

7. The method according to claim 1, further comprising:
applying the color to a wallpaper of electronic device.

8. The method according to claim 1, further comprising:
repeating the steps (a) to (c) to generate a plurality of rimmed icons; and
displaying the rimmed icons in the GUI.

9. The method according to claim 8, wherein the step of displaying the rimmed icons in the GUI comprises:
displaying together the rimmed icons with the background image having the similar color in the GUI.

10. The method according to claim 1, wherein the background image is a filled rectangular shape or a hollow rectangular shape or has a shift distance of the icon or has a shift angle of the icon.

11. An electronic device, comprising:
a screen, for displaying a GUI of the electronic device;
a color determining module, for determining a color of a background image with a predetermined size for an application program according to a dynamic styling rule; and
a GUI rendering module, coupled to the screen and the color determining module, for applying the color to the background image, combining the background image with an icon of the application program to generate a rimmed icon, displaying the rimmed icon in the GUI, and dominating the screen to display the GUI.

12. The electronic device according to claim 11, wherein the dynamic styling rule is relevant to at least one of an attribute of the application program and a usage situation of the electronic device.

13. The electronic device according to claim 11, wherein the color determining module obtains a plurality of predetermined function categories and a predetermined color corresponding to each of the predetermined function categories, and analyzes a function category of the application program,
if the function category of the application program is consistent with one of the predetermined function categories, the color determining module defines the color of the background image as the predetermined color corresponding to the consistent predetermined function category.

14. The electronic device according to claim 11, wherein the color determining module analyzes a color distribution of the icon of the application program, picks a dominant color according to the color distribution, and defines the color of the background image as the dominant color.

15. The electronic device according to claim 11, wherein the color determining module analyzes a color tone of a current wallpaper of the electronic device when a wallpaper altering signal is detected, and matches the color of the background image with the color tone.

16. The electronic device according to claim 11, wherein the color determining module identifies a user of the electronic device; and defines the color of the background image according to an identity of the user.

17. The electronic device according to claim 11, wherein the GUI rendering module applys the color to a wallpaper of electronic device.

18. The electronic device according to claim 11, wherein the color determining module respectively determines the color of the background image for each of a plurality of application programs according to the dynamic styling rule,
for each of the application programs, the GUI rendering module applies the color to the corresponding background image, combines the background image and a corresponding icon of the application program, so as to generate a plurality of rimmed icons corresponding to the application programs, and then displays the rimmed icons in the GUI.

19. The electronic device according to claim 18, wherein the GUI rendering module displays together the rimmed icons with the background image having the similar color in the GUI.

20. The electronic device according to claim 11, wherein the background image is a filled rectangular shape or a hollow rectangular shape or has a shift distance of the icon or has a shift angle of the icon.
